(19) United States
(12) Patent Application Publication
(10) Pub. No.: US 2026/0343294 A1
(43) Pub. Date: Oct. 29, 2026

(54) INTERFERENCE MEASUREMENT FOR FULL DUPLEX WIRELESS COMMUNICATIONS

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 19/189,143

(22) Filed: Apr. 24, 2025

(51) Int. Cl. H04W 24/10; H04W 72/21; H04W 72/231

(52) U.S. Cl. CPC H04W 24/10; H04W 72/21; H04W 72/231

(57) ABSTRACT

This disclosure provides methods, components, devices, and systems for interference measurement for full duplex wireless communications. For example, a network entity may provide a measurement configuration to a user equipment (UE) that indicates measurement resources for measuring cross-link interference (CLI) and self-interference (SI). The measurement configuration may indicate linked transmission resources for an uplink transmission that is concurrent with the resource for measuring SI, and the network entity may jointly trigger measurement and an uplink transmission for SI measurement. The UE may provide a measurement report that indicates one or more metrics based on measured SI, CLI, or both, which may be used to determine whether to enable full-duplex communications at the UE, one or more full-duplex parameters, or both.

### TECHNICAL FIELD

This disclosure relates generally to wireless communication, and more specifically to systems, devices, methods, and techniques associated with interference measurement for full duplex wireless communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a measurement configuration that indicates at least a first resource for transmission of an uplink signal for a self-interference measurement and a second resource for the self-interference measurement, transmitting the uplink signal using the first resource concurrently with performance of the self-interference measurement on the second resource, and transmitting a measurement report that indicates the self-interference measurement.

A UE for wireless communications is described. The UE may include a processing system that includes processor circuitry and memory circuitry that stores code. The processing system may be configured to cause the UE to receive a measurement configuration that indicates at least a first resource for transmission of an uplink signal for a self-interference measurement and a second resource for the self-interference measurement, transmit the uplink signal using the first resource concurrently with performance of the self-interference measurement on the second resource, and transmit a measurement report that indicates the self-interference measurement.

Another UE for wireless communications is described. The UE may include means for receiving a measurement configuration that indicates at least a first resource for transmission of an uplink signal for a self-interference measurement and a second resource for the self-interference measurement, means for transmitting the uplink signal using the first resource concurrently with performance of the self-interference measurement on the second resource, and means for transmitting a measurement report that indicates the self-interference measurement.

A non-transitory computer-readable medium storing code for wireless communications is described. The code may include instructions executable by one or more processors to receive a measurement configuration that indicates at least a first resource for transmission of an uplink signal for a self-interference measurement and a second resource for the self-interference measurement, transmit the uplink signal using the first resource concurrently with performance of the self-interference measurement on the second resource, and transmit a measurement report that indicates the self-interference measurement.

In some examples of the method, UEs, and non-transitory computer-readable medium described herein, the first resource and the second resource include a same time domain symbol. In some examples of the method, UEs, and non-transitory computer-readable medium described herein, the UE may be a first UE, and the measurement configuration further indicates a third resource for measurement of cross-link interference from an uplink transmission of a second UE during concurrent reception of downlink communications at the first UE, and where the measurement report indicates the self-interference measurement and a cross-link interference measurement measured on the third resource.

Some examples of the method, UEs, and non-transitory computer-readable medium described herein may further include operations, features, means, or instructions for receiving a trigger message that initiates transmission of the uplink signal using the first resource and that initiates the self-interference measurement on the second resource. Some examples of the method, UEs, and non-transitory computer-readable medium described herein may further include operations, features, means, or instructions for receiving an aperiodic trigger message that initiates the self-interference measurement and a cross-link interference measurement, and where transmitting the measurement report may be based on the aperiodic trigger message.

Some examples of the method, UEs, and non-transitory computer-readable medium described herein may further include operations, features, means, or instructions for measuring, during a time domain symbol of the second resource that includes the uplink signal, one or more self-interference metrics for one or more downlink sub-bands of the second resource. In some examples of the method, UEs, and non-transitory computer-readable medium described herein, the one or more self-interference metrics include one or more received signal strength indicator (RSSI) metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

In some examples of the method, UEs, and non-transitory computer-readable medium described herein, the second resource may be identified based on a CLI measurement resource information element provided in the measurement configuration. In some examples of the method, UEs, and non-transitory computer-readable medium described herein, the second resource includes at least two least two time domain symbols, including a first time domain symbol that overlaps with the first resource and a second time domain symbol for measurement of CLI. In some examples of the method, UEs, and non-transitory computer-readable medium described herein, the second resource includes at least two least two time domain symbols, including a first time domain symbol for measurement of self-interference plus CLI, and a second time domain symbol for measurement of CLI only.

In some examples of the method, UEs, and non-transitory computer-readable medium described herein, a transmit power for transmission of the uplink signal may be based on one or more of a TCI power control parameter, a default power control parameter, or a configured power control parameter provided with the measurement configuration.

A method for wireless communications by a network entity is described. The method may include outputting, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource, obtaining, from the UE, a measurement report that indicates the self-interference measurement, and scheduling the UE with one or more full-duplex resources for communications based on the self-interference measurement.

A network entity for wireless communications is described. The network entity may include a processing system that includes processor circuitry and memory circuitry that stores code. The processing system may be configured to cause the network entity to output, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource, obtain, from the UE, a measurement report that indicates the self-interference measurement, and schedule the UE with one or more full-duplex resources for communications based on the self-interference measurement.

Another network entity for wireless communications is described. The network entity may include means for outputting, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource, means for obtaining, from the UE, a measurement report that indicates the self-interference measurement, and means for scheduling the UE with one or more full-duplex resources for communications based on the self-interference measurement.

A non-transitory computer-readable medium storing code for wireless communications is described. The code may include instructions executable by one or more processors to output, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource, obtain, from the UE, a measurement report that indicates the self-interference measurement, and schedule the UE with one or more full-duplex resources for communications based on the self-interference measurement.

In some examples of the method, network entities, and non-transitory computer-readable medium described herein, the first resource and the second resource include a same time domain symbol. In some examples of the method, network entities, and non-transitory computer-readable medium described herein, the UE may be a first UE, and the measurement configuration further indicates a third resource for measurement of cross-link interference from an uplink transmission of a second UE during concurrent reception of downlink communications at the first UE, and where the measurement report indicates the self-interference measurement and a cross-link interference measurement measured on the third resource.

Some examples of the method, network entities, and non-transitory computer-readable medium described herein may further include operations, features, means, or instructions for outputting a trigger message to the UE that initiates transmission of the uplink signal using the first resource and that initiates the self-interference measurement on the second resource. Some examples of the method, network entities, and non-transitory computer-readable medium described herein may further include operations, features, means, or instructions for outputting an aperiodic trigger message to the UE that initiates the self-interference measurement and a cross-link interference measurement, and where the measurement report may be provided responsive to the aperiodic trigger message. In some examples of the method, network entities, and non-transitory computer-readable medium described herein, the measurement configuration indicates a set of multiple second resources for self-interference measurements and the method, apparatuses, and non-transitory computer-readable medium may include further operations, features, means, or instructions for outputting an aperiodic trigger message to the UE that initiates transmission of the measurement report.

In some examples of the method, network entities, and non-transitory computer-readable medium described herein, the measurement configuration indicates that the UE is to measure, during a time domain symbol of the second resource that includes the uplink signal, one or more self-interference metrics for one or more downlink sub-bands of the second resource. In some examples of the method, network entities, and non-transitory computer-readable medium described herein, the one or more self-interference metrics include one or more RSSI metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

In some examples of the method, network entities, and non-transitory computer-readable medium described herein, the second resource may be identified based on a CLI measurement resource information element provided in the measurement configuration. In some examples of the method, network entities, and non-transitory computer-readable medium described herein, the second resource includes at least two least two time domain symbols, including a first time domain symbol that overlaps with the first resource and a second time domain symbol for measurement of CLI. In some examples of the method, network entities, and non-transitory computer-readable medium described herein, the second resource includes at least two least two time domain symbols, including a first time domain symbol for measurement of self-interference plus CLI, and a second time domain symbol for measurement of CLI only.

In some examples of the method, network entities, and non-transitory computer-readable medium described herein, a transmit power for transmission of the uplink signal may be based on one or more of a TCI power control parameter, a default power control parameter, or a configured power control parameter provided with the measurement configuration.

### BRIEF DESCRIPTION OF THE DRAWINGS

FIG. 1 shows an example of a wireless communication system.

FIG. 2 shows an example of a signaling configuration that supports interference measurement for full duplex wireless communications.

FIG. 3 shows an example of noise levels associated with cross-link interference and self-interference that supports interference measurement for full duplex wireless communications.

FIG. 4 shows an example of a resource configuration that supports interference measurement for full duplex wireless communications.

FIG. 5 shows an example of a process flow that supports interference measurement for full duplex wireless communications.

FIG. 6 shows a block diagram of a processing system that supports interference measurement for full duplex wireless communications.

FIG. 7 shows a diagram of a system including a device that supports interference measurement for full duplex wireless communications.

FIG. 8 shows a block diagram of a processing system that supports interference measurement for full duplex wireless communications.

FIG. 9 shows a diagram of a system including a device that supports interference measurement for full duplex wireless communications.

FIGS. 10 through 13 show flowcharts illustrating methods that support interference measurement for full duplex wireless communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, full-duplex communications techniques may be implemented in which a same set of wireless resources within a time division duplexing (TDD) radio frame are used for both uplink communications from a user equipment (UE) to a network entity and downlink communications from the network entity to one or more UEs. In some deployments, SBFD may be used in which a set of frequency resources may include one or more uplink sub-bands and one or more downlink sub-bands that are non-overlapping. In other deployments, full-duplex communications techniques may include overlapping uplink and downlink frequency resources. Although various examples discussed herein illustrate SBFD resources, techniques provided herein may also be used in full-duplex communications in which uplink and downlink communications use overlapping frequency resources within a same time period. In some cases, a SBFD configuration may provide a set of SBFD slots within a TDD configuration, such that some slots within a TDD radio frame are SB FD slots and remaining slots within the TDD radio frame are non-full-duplex slots. In some cases, non-full-duplex slots may also be referred to as legacy slots.

In some cases, a network entity may concurrently transmit and receive communications, and each UE that communicates with the network entity only transmits or receives during a particular time period using either downlink sub-bands or uplink sub-bands associated with the SBFD communications. In order to manage potential interference between UEs, the network entity may configure interference measurement resources for cross-link interference (CLI), in which a UE may measure interference of an uplink transmission from another UE for use in managing uplink and downlink communication parameters of SBFD communications. However, in cases where it may be desirable for a UE to concurrently transmit and receive communications in accordance with full-duplex techniques, additional interference information may be beneficial, such as self-interference (SI) measurements, a difference between SI and CLI, or both. Thus, efficient techniques for configuring and providing information related to such interference measurements may be desirable.

Aspects of the subject matter described in this disclosure relate to interference measurement techniques for full-duplex communications. For example, a network entity may provide a measurement configuration to a UE that indicates measurement resources for measuring CLI, and CLI plus SI. In some aspects, the measurement configuration may indicate linked transmission resources for an uplink transmission that is concurrent with the resource for measuring SI. In some aspects, the network entity may configure a joint triggering and measurement resource, with an uplink transmission used for residual SI measurement. In some examples, the measurement resource and the uplink transmission may both be aperiodically triggered with a joint aperiodic trigger that initiates both the measurement and uplink transmission. In other examples, the measurement resource may be semi-persistent or periodic (SP/P) and the UL transmission may be aperiodic, and triggering of an aperiodic measurement report associated with the measurement resource may implicitly trigger the uplink transmission. In some aspects, both the measurement resource and the uplink transmission resource may be SP/P, and a same message (e.g., a medium access control (MAC) control element (CE)) that activates an uplink transmission resource may trigger a measurement report, or a same message that triggers the measurement report may activate the uplink transmission resource.

In some aspects, a UE may provide a measurement report that indicates one or more metrics based on measured SI, CLI, or both. In some aspects, a measurement report may include metrics for SI that include received signal strength indicator (RSSI) measurements, a delta RSSI measurement relative to a CLI measurement, transmit power metrics related to desense (e.g., a reduced sensitivity of the UE receiver due to interference), a power reduction to obtain a certain amount of desense (e.g., 1 dB of desense), or any combination thereof. In some aspects, the measurement resource may include at least two OFDM symbols (e.g., a first symbol for CLI+SI measurement, and a second symbol for CLI measurement only).

Additionally, or alternatively, a transmit power control for the uplink transmission associated with the SI measurement may be based on a trigger for the uplink transmission. For example, if the uplink transmission is triggered explicitly, power control may be performed in accordance with a TCI power control parameter. In some examples, if the uplink transmission is implicitly triggered (e.g., the uplink transmission is an aperiodic sounding reference signal (SRS) transmitted based on an aperiodic measurement resource) an indication of the aperiodic measurement resource (e.g., SRS resource) may include a flag that indicates to use a TCI power control parameter or to use a default power control parameter (e.g., that is configured for an associated bandwidth part (BWP)). In further examples, the measurement report configuration may include power control information (e.g., a power hypothesis) for the uplink transmission.

Particular aspects of the subject matter described in this disclosure can be implemented to realize one or more of the following potential advantages. In some examples, by providing a measurement configuration with SI and CLI measurement resources, the described techniques can be used to provide information for both SI and CLI, which may allow a network entity to determine whether to enable full-duplex communications at a UE, parameters for full-duplex communications, or both. In some aspects, by providing linked transmission resources for an uplink transmission that is concurrent with the resource for measuring SI, signaling overhead may be reduced. Additionally, by providing joint uplink signal triggering and measurement, some aspects may enable the uplink transmission, measurement, and reporting of interference measurements with a single aperiodic trigger. Further, by reporting metrics such as RSSI, delta RSSI relative to a CLI measurement, or transmit power metrics, some aspects may provide that a size of the measurement report may be reduced relative to providing full information related to interference metrics and transmit power.

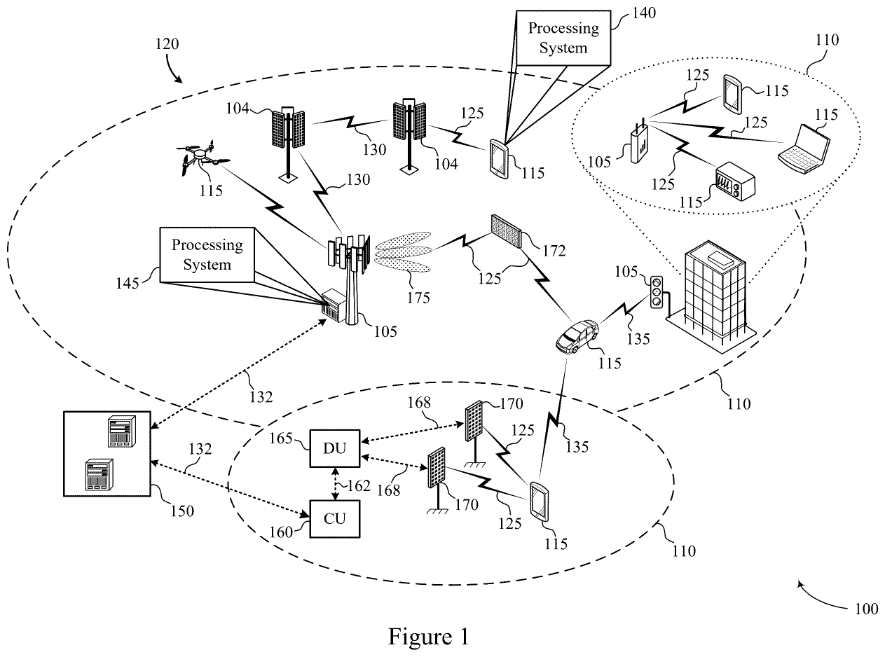

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5G C) or 6G core (6G C), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. W ireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active D L BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DM RSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for interference measurement for full duplex wireless communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support providing a measurement configuration with SI and CLI measurement resources, and reporting of metrics related to SI, CLI, or both, which may allow a network entity to efficiently determine whether to enable full-duplex communications at a UE, parameters for full-duplex communications, or both.

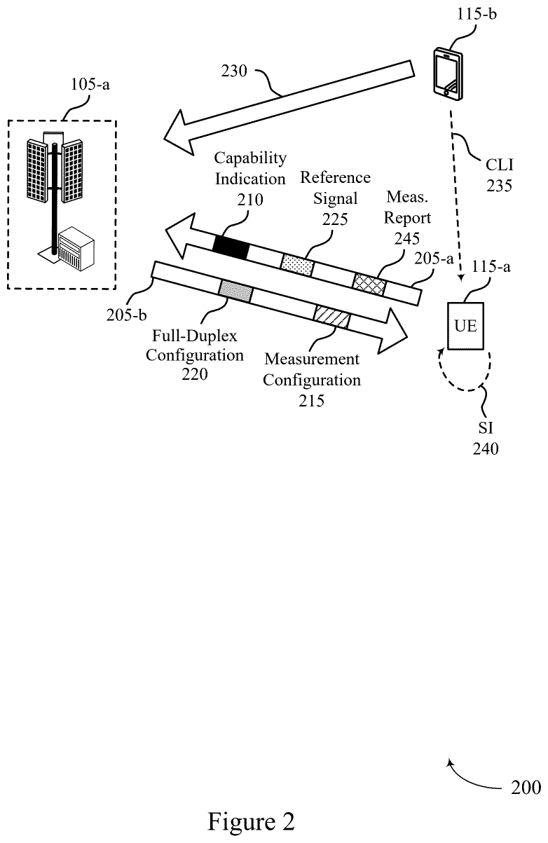

FIG. 2 shows an example of a signaling configuration 200 that supports interference measurement for full duplex wireless communications. The signaling configuration 200 may implement or be implemented by aspects of the wireless communications system 100 as described herein with reference to FIG. 1. For example, the signaling configuration 200 may include a first UE 115-a, a second UE 115-b, and a network entity 105-a, which may be an example of UEs 115 and network entities 105 as described herein with reference to FIG. 1. The signaling configuration 200 may support 3G, 4G, 5G, 6G, or radio access technologies beyond 6G.

The first UE 115-a and the network entity 105-a may perform wireless communication (e.g., one or more of receiving, obtaining, transmitting, or outputting one or more of control information, configuration information, or data) via a first communication link 205, including uplink communication link 205-a and downlink communication link 205-b, which may be examples of communications links 125 as described herein with reference to FIG. 1. In some cases, communication link 205 may include multiple component carriers. In the example of FIG. 2, the UE 115-a may be capable of full-duplex operation for communications with the network entity 105-a. In such examples, the UE 115-a may transmit a capability indication 210 to the network entity 105-a that indicates full-duplex capabilities, measurement capabilities, reporting capabilities (e.g., including supported timing between trigger signals and measurements or transmissions), or any combination thereof. In the example of FIG. 2, the second UE 115-b and the network entity 105-a may perform wireless communication via second communication link 230. In some cases, the second UE 115-b may transmit uplink communications via the second communication link 230 while the first UE 115-a receives downlink communications via downlink communication link 205-b, which may generate CLI 235 between the second UE 115-b and the first UE 115-a.

In accordance with various aspects, the network entity 105-a may provide configuration information 220 to the first UE 115-a related to full-duplex operation (e.g., a SBFD configuration, or in-band full-duplex (IBFD) configuration in which concurrent uplink and downlink communications have overlapping frequencies). The network entity 105-a may also transmit a measurement configuration 215 to the first UE 115-a, which may indicate SI and CLI measurement resources, uplink transmission resources for an uplink reference signal 225, or any combination thereof. In some aspects, the first UE 115-a may transmit the reference signal 225 during a first symbol that is indicated in the measurement configuration 215, while measuring interference on measurement resources of the first symbol that are indicated in the measurement configuration 215, to obtain a metric associated with SI 240. In some aspects, the measurement configuration 215 may also indicate measurement resources associated with a second symbol that may be used to measure CLI 235, inter-cell interference, or both. The first UE 115-a may transmit a measurement report 245 that indicates metrics related to SI, CLI, or both, which may allow the network entity 105-a to efficiently determine whether to enable full-duplex communications at the first UE 115-a, parameters for full-duplex communications, or both.

In some aspects, the configuration information 220 may indicate that the first UE 115-a is to operate in accordance with a SBFD configuration, in which a component carrier bandwidth is split into non-overlapping uplink and downlink sub-band(s) to enable simultaneous transmission and reception. Such full-duplex operation may improve uplink coverage by enabling contiguous uplink transmission in uplink sub-band(s) across multiple consecutive SBFD slots, which may improve uplink SINR, and reduce latency. In some aspects, the first UE 115-a may be configured to concurrently receive downlink communications via the downlink communication link 205-b while transmitting via the uplink communication link 205-a based on one or more metrics indicated in the measurement report 245. In some aspects, the first UE 115-a may have a form factor that is amenable to antenna placement that provides sufficient spatial isolation for efficient full-duplex communications, and may be, for example, a customer premises equipment (CPE), laptop, repeater, vehicle, and the like. In some aspects, the first UE 115-a may be a handheld device.

In some aspects, whether to enable the first UE 115-a to operate in a full-duplex mode with concurrent uplink and downlink transmissions may be based on interference levels associated with such communications. For example, the first UE 115-a may be configured for full-duplex communications opportunistically based on interference levels. In some cases, UEs may have limited SI mitigation capability (α), where the residual SI (I) per resource block (RB) may be given by a relation between a per-RB power level (p) and α as:

$${I}_{SI}^{per - RB} = \frac{{P}_{tx}^{per - RB}}{{α}_{SI}}$$

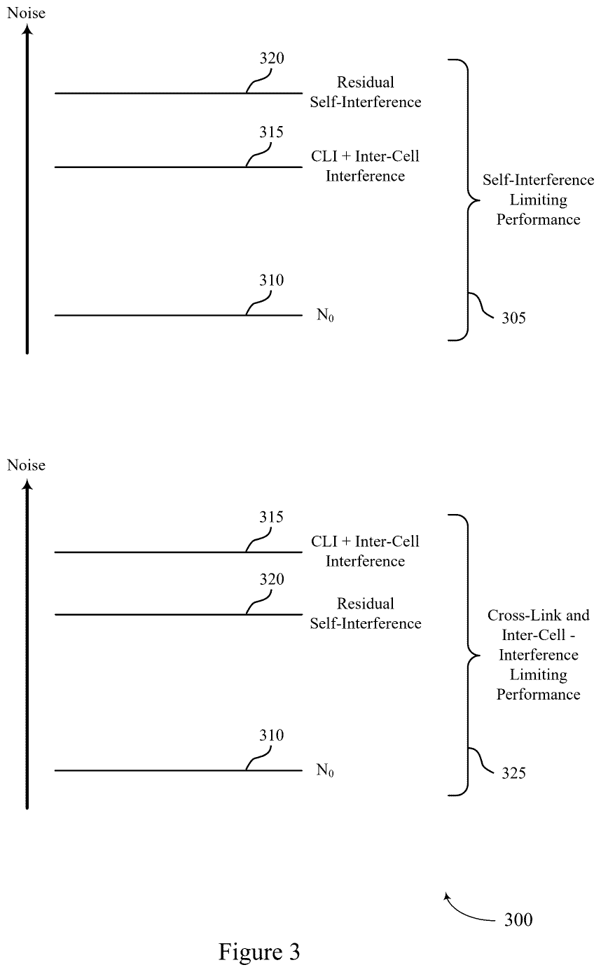

The impact of the residual SI on overall desense (e.g., a receiver's reduced sensitivity due to interference) may depend on the transmit power and an ICI compared to residual desense. In some cases, the residual SI may be equal to a maximum power minus a SI cancellation factor (e.g., I_{RSI}=Pₘₐₓ−α_{SIC}). FIG. 3 illustrates examples of cases where full-duplex performance may be limited by SI or by other interference.

FIG. 3 shows examples of noise levels 300 associated with cross-link interference and self-interference that support interference measurement for full duplex wireless communications. In some cases, aspects of the noise levels 300 may be implemented by aspects of a wireless communications system 100 or signaling configuration 200, as described with reference to FIGS. 1 and 2. For example, the noise levels 300 may be associated with a UE that concurrently transmits and receives wireless communications in accordance with a full-duplex configuration.

In a first example 305, a residual SI 320 may be greater than a CLI and inter-cell interference 315 level, above a level of background noise 310 (N₀). Inter-cell interference 315 may occur, for example, due to downlink transmission of neighboring network entities in other cells or sectors. Thus, in this first example 305, the residual SI 320 is limiting performance at the UE. However, in a second example 325, the CLI plus inter-cell interference 315 may be greater than the residual SI 320. Thus, in this second example 325, the CLI and inter-cell interference is limiting performance at the UE. In accordance with various aspects, a UE operating in accordance with the second example 325 may be configured for full-duplex communications in which the UE concurrently transmits and receives, while a UE operating in accordance with the first example 305 may be configured for half-duplex communications.

With reference again to FIG. 2, the first UE 115-a may provide a measurement report 245 that indicates various interference-related metrics. In some cases, the network entity 105-a may configure a CLI RSSI resource and simultaneously trigger an uplink transmission of reference signal 225 from the first UE 115-a. In such cases, an explicit linkage between the RSSI measurement resource and the uplink transmission of reference signal 225 may not be provided, and the network entity 105-a may trigger the measurement and uplink transmission separately. In other aspects, the measurement configuration 215 may define a relationship between the CLI measurement resource and the uplink transmission of reference signal 225. In some aspects, the measurement configuration 215 may enable joint triggering of the CLI measurement and the uplink transmission of reference signal 225, which may reduce signaling overhead relative to separate indications. Further, such joint triggering may ensure the alignment of the measurement resource with the uplink transmission of reference signal 225.

In some aspects, the measurement configuration 215 may provide for an aperiodic measurement resource and aperiodic reporting, as well as an aperiodic uplink transmission of reference signal 225. In such aspects, an aperiodic trigger for an SI and CLI measurement resource may also trigger the uplink transmission of reference signal 225 (e.g., SRS or dynamic grant physical uplink shared channel (PUSCH) transmission). In some cases, a downlink control information (DCI) transmission may trigger the measurement resource and aperiodic measurement report 245, and the uplink transmission of reference signal 225 may be triggered implicitly (e.g., DCI triggers SI-RSSI resource and the associated aperiodic SRS). In some cases, a DCI may trigger the uplink transmission of reference signal 225, and the associated measurement resource may be triggered implicitly (e.g., DCI triggers a special SRS with SI measurement usage, and the associated measurement resource).

In some aspects, the measurement configuration 215 may provide for a SP/P measurement resource and an aperiodic uplink transmission of reference signal 225. In such aspects, joint triggering may not be supported given that the uplink transmission resource and measurement resource have different timing behavior (e.g., a MAC-CE triggers the SP resource and DCI triggers the aperiodic uplink transmission of reference signal 225). In some cases, triggering of the aperiodic reporting may implicitly trigger the aperiodic uplink transmission of reference signal 225. In some further aspects, the measurement configuration 215 may provide for a SP/P measurement resource and a SP/P uplink transmission of reference signal 225. In such aspects, a MAC-CE may activate the measurement resource and the associated uplink transmission of reference signal 225 may be triggered implicitly, or a MAC-CE may activate the uplink transmission of reference signal 225 and the associated measurement resource may be triggered implicitly.

In some aspects, to enable joint triggering of SI measurement and uplink transmission of reference signal 225, a linkage may be defined. In some cases, the SI measurement and uplink transmission of reference signal 225 may be linked by RRC configuration of the measurement resource (e.g., the RSSI measurement resource includes a field for associating an SRS-resource). In other cases, the SI measurement and uplink transmission of reference signal 225 may be linked by RRC configuration of the reference signal 225 (e.g., define an SRS with special/dual usage that includes ‘SI-measurement’ and the RRC configuration of the SRS includes a field for associating a measurement resource). In further cases, the SI measurement and uplink transmission of reference signal 225 may be linked by a field in a channel state information (CSI) resource configuration (e.g., a field for an associated uplink signal in CSI-resourceConfig). In other cases, the SI measurement and uplink transmission of reference signal 225 may be linked by a field in a CSI report configuration (e.g., a field for an associated uplink signal in CSI-reportConfig). Such a configuration may also be used for an aperiodic uplink transmission of reference signal 225. Further, if SP/P reporting is supported, the SP/P reporting may be linked to a SP/P uplink signal and have a same timing behavior.

In some aspects, the measurement report 245 may include metrics that indicate measured interference at the first UE 115-a, which may quantify the SI leakage to downlink sub-bands at the first UE 115-a. In some cases, the measurement report 245 may include one or more R SSI measurements in one or more downlink sub-bands. In some cases, additionally, or alternatively, a delta RSSI metric may be provided, that indicates additional RSSI due to SBFD operation at the first UE 115-a. In such cases, the measurement report 245 may indicate a CLI RSSI metric and a SI-delta-RSSI metric, which may be used by the network entity 105-a to determine the impact of both CLI and SI interference. In such cases, the measurement configuration 215 may provide that a same or similar set of CLI conditions is present in the two measurement resources or occasions. Additionally, or alternatively, the measurement report 245 may indicate one or more transmit power related metrics, such as extra desense due to SI, a power reduction needed to get 1 dB desense, or both. Such power-related metrics may be used as a guideline for reducing SI by reducing uplink transmit power, and may be used in addition to a power headroom report.

In some aspects, an uplink transmit power for the uplink transmission of reference signal 225 may be determined in accordance with one or more uplink transmit power techniques. In some cases, if the uplink transmission of reference signal 225 is triggered explicitly, a corresponding power control may be performed in accordance with established power control techniques, such as for unified transmission configuration indicator (TCI) power control. In some cases, if the uplink transmission of reference signal 225 is implicitly triggered (e.g., aperiodic SRS based on an aperiodic measurement resource), the reference signal 225 resource configuration may include a flag that indicates to follow unified-TCI and if a flag is not configured a default power control parameter defined in the BWP may be used, or the measurement configuration may include power control information (e.g., a power hypothesis) used for the uplink transmission of reference signal 225.

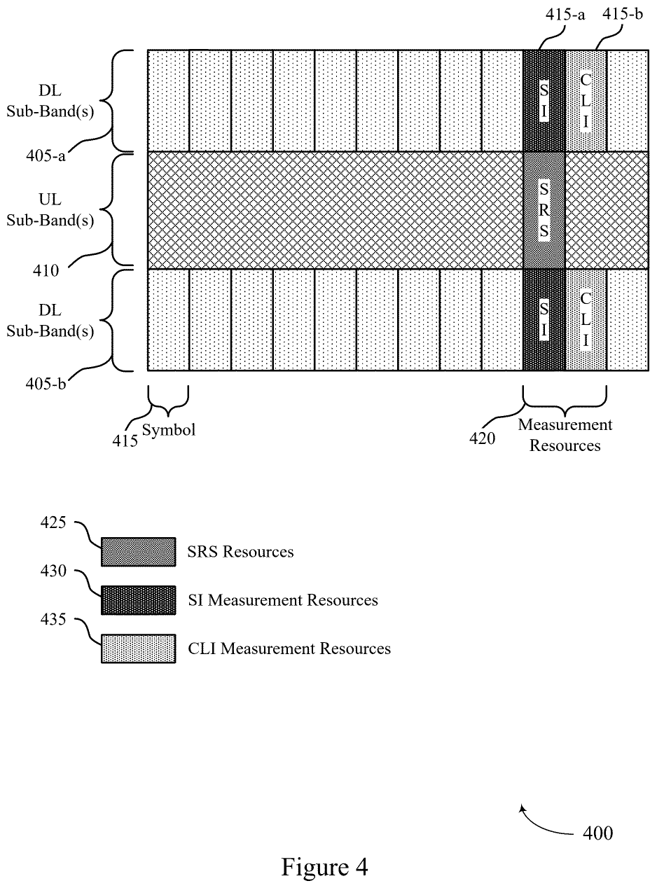

FIG. 4 shows an example of a resource configuration 400 that supports interference measurement for full duplex wireless communications. In some cases, aspects of the resource configuration 400 may implement or be implemented by aspects of a wireless communications system 100 or signaling configuration 200, as described with reference to FIGS. 1 and 2. For example, the resource configuration 400 may be configured at a network entity 105 and a UE 115, which may be examples of a network entity 105 and UE 115 as described with reference to FIGS. 1 and 2.

In this example, a TDD frame may be configured with a TDD configuration that indicates one or more slots, such as illustrated in FIG. 4, as a SBFD slot. The TDD configuration may also configure one or more slots as uplink slots, or downlink slots, although SBFD slot is illustrated in FIG. 4 for purposes of illustration and discussion. Each slot may have one or more associated downlink sub-bands 405 and one or more uplink sub-bands 410. In the example of FIG. 4, a first subset of downlink sub-band(s) 405-a and a second subset of downlink sub-band(s) 405-b may be located above and below, respectively, the one or more uplink sub-bands 410. In this example, a set of measurement resources 420 may be configured to facilitate SI and CLI measurements at a UE. Each slot may have multiple OFDM symbols 415. In some aspects, the measurement resources 420 may include at least two symbols, in which at least a first symbol 415-a overlaps with uplink transmission resources 425 (e.g., SRS resources), and other symbols such as second symbol 415-b without an uplink transmission can be used for CLI measurement. SI measurement resources 430 may be used to measure SI+CLI and may be configured in the downlink sub-bands 405 of the first symbol 415-a, and CLI measurement resources 435 may be configured in the downlink sub-bands 405 of the second symbol 415-b (e.g., for measurement of CLI only).

In some aspects, the first symbol 415-a (and optionally one or more other symbols) for SI measurement may be either explicitly defined in RRC or implicitly determined based on the uplink transmission resources 425. In some cases, the SI measurement symbol(s) may be defined by adding a start and/or end symbol or RB to a definition of a CLI-RSSI measurement resource. In other cases, the location of SI measurement symbol(s) may be fixed (e.g., first X symbols or last X symbols in the measurement resource). In some aspects, the CLI measurement resources 435 (e.g., CLI-RSSI-MeasurementResourceSet) may include at least two CLI measurement resources (e.g., one for CLI+SI and one for CLI only). In some cases, the SI measurement resources 430 may be defined or fixed within a set of measurement resources 420 (e.g., a first resource or resource with smallest ID value is assumed to be for SI measurement). In other cases, the SI measurement resources 430 may be configurable in the measurement resources 420 (e.g., through RRC configuration). In further cases, separate measurement resources may be defined for SI measurement resources 430 and CLI measurement resources 435, and the two sets (e.g., CLI only and CLI+SI) may be linked by RRC configuration.

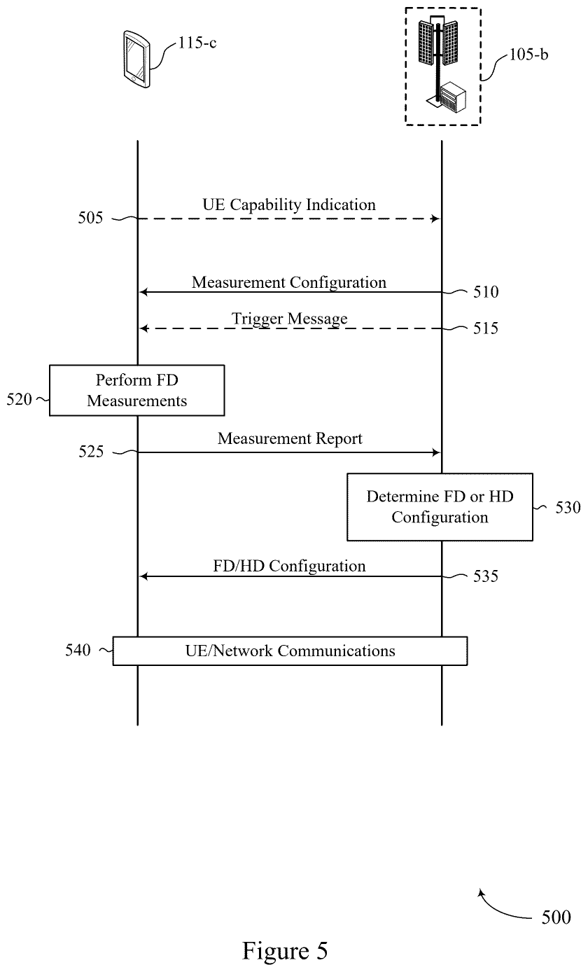

FIG. 5 shows an example of a process flow 500 that supports interference measurement for full duplex wireless communications. In some cases, aspects of the process flow 500 may implement or be implemented by aspects of a wireless communications system 100 or signaling configuration 200, or resource configuration 400, as described with reference to FIGS. 1 through 4. For example, the process flow 500 may include a UE 115-c, which may be an example of a UE 115 as described with reference to FIGS. 1 through 4. Additionally, the process flow 500 may include a network entity 105-b, which may be an example of a network entity 105 as described with reference to FIGS. 1 through 11.

In the following description of the process flow 500, the operations may be performed in a different order than the order shown. Additionally, or alternatively, other operations may be added or removed from the process flow 500. Although the UE 115-c, and the network entity 105-b are shown performing the operations of the process flow 500, some aspects of some operations may be performed by one or more other devices (e.g., other UEs 115, other network entities 105, or other entities external to the network).

At 505, optionally, the UE 115-c may transmit, and the network entity 105-b may receive, a UE capability indication. In some cases, the UE capability indication may be provided via RRC signaling with other capabilities of UE 115-c. In some cases, the UE capability indication may be provided in response to a query from the network entity 105-b. In some cases, the UE capability indication may indicate that the UE 115-c supports full-duplex operation. In some cases, the UE capability indication may indicate support for measurement timing (e.g., a timing between a DCI trigger and transmission of an uplink reference signal), one or more types of supported measurements (e.g., RSSI, delta RSSI, etc.), or any combination thereof.

At 510, the network entity 105-b may transmit, and the UE 115-c may receive, a measurement configuration. In some cases, the measurement configuration may be provided for full-duplex measurements of SI and CLI at the UE 115-c. In some cases, the measurement configuration may indicate one or more uplink resources for transmission of an uplink reference signal, one or more downlink resource for SI (or SI+CLI) measurements, and one or more downlink resource for CLI measurements. In some cases, the measurement configuration may indicate a linkage between a RSSI measurement resource and an uplink resource for transmission of the uplink reference signal. Optionally, at 515, the network entity 105-b may transmit, and the UE 115-c may receive, a trigger message. The trigger message may be provided as discussed with reference to FIG. 2 such as, for example, in DCI and may indicate that an aperiodic measurement or uplink reference signal transmission is to be initiated.

At 520 the UE 115-c may perform full-duplex measurements in accordance with the measurement configuration. In some aspects, the UE 115-c may transmit an uplink reference signal using uplink resource concurrently with measuring one or more interference levels of one or more measurement resources. Further, the UE 115-c may measure one or more interference levels in one or more measurement resources that do not overlap with an uplink signal transmission of the UE, to provide a CLI measurement, inter-cell interference measurement, or both. At 525, the UE 115-c may transmit, and the network entity 105-b may receive, a measurement report. The measurement report may be transmitted via an uplink control channel, for example.

At 530, the network entity 105-b may determine a full-duplex configuration for communications. In some aspects, the network entity 105-b may determine that the UE 115-c has a level of SI or residual SI that supports full-duplex communications at the UE 115-c (e.g., a residual SI level is lower than a CLI level), and may configure the UE 115-c for full-duplex (FD) communications. In other aspects, the network entity 105-b may determine that the UE 115-c has a level of SI or residual SI that does not support full-duplex communications at the UE 115-c (e.g., a residual SI level is higher than a CLI level), and may configure the UE 115-c for half-duplex (H D) communications. At 535, the network entity 105-b may transmit, and the UE 115-c may receive, a full-duplex configuration in accordance with the determination at the network entity 105-b. At 540, the UE 115-c and network entity 105-b may communicate in accordance with the full-duplex or half-duplex configuration.

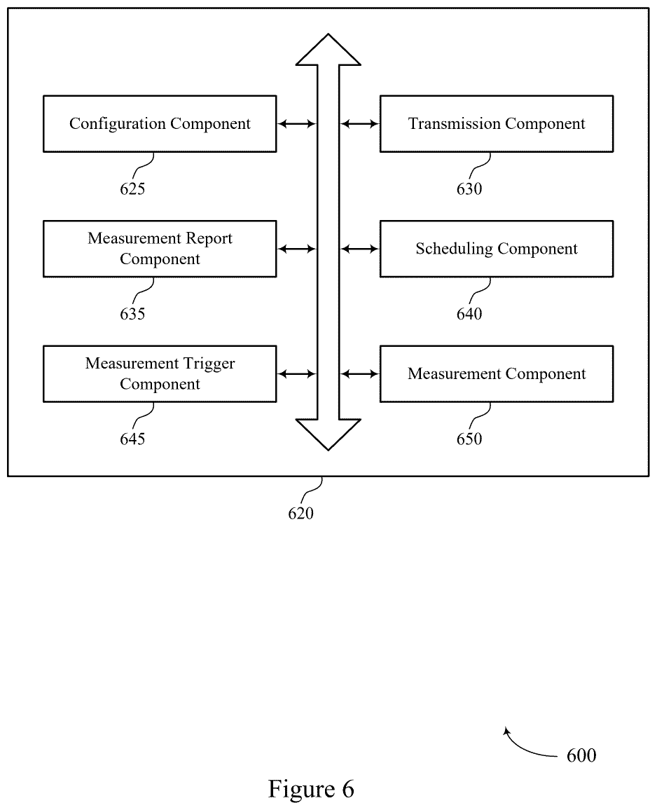

FIG. 6 shows an example 600 of a processing system 620 that supports interference measurement for full duplex wireless communications. A processing system 620 may be an example of a processing system 140 (such as of a UE 115) and may include a configuration component 625, a transmission component 630, a measurement report component 635, a scheduling component 640, a measurement trigger component 645, a measurement component 650, or any combination thereof. A processing system 620, or various component thereof, may be an example of means for performing (such as a means for causing a UE 115 to perform) various techniques described herein.

The configuration component 625 may be configured to cause the UE 115 to receive a measurement configuration that indicates at least a first resource for transmission of an uplink signal for a self-interference measurement and a second resource for the self-interference measurement. The transmission component 630 may be configured to cause the UE 115 to transmit the uplink signal using the first resource concurrently with performance of the self-interference measurement on the second resource. The measurement report component 635 may be configured to cause the UE 115 to transmit a measurement report that indicates the self-interference measurement.

In some examples, the first resource and the second resource include a same time domain symbol. In some examples, the UE is a first UE, and the measurement configuration further indicates a third resource for measurement of cross-link interference from an uplink transmission of a second UE during concurrent reception of downlink communications at the first UE, and where the measurement report indicates the self-interference measurement and a cross-link interference measurement measured on the third resource.

In some examples, the measurement trigger component 645 may be configured to cause the UE 115 to receive a trigger message that initiates transmission of the uplink signal using the first resource and that initiates the self-interference measurement on the second resource. In some examples, the measurement trigger component 645 may be configured to cause the UE 115 to receive an aperiodic trigger message that initiates the self-interference measurement and a cross-link interference measurement, and where transmitting the measurement report is based on the aperiodic trigger message. In some examples, the measurement configuration indicates a set of multiple second resources for self-interference measurements, and the measurement trigger component 645 may be configured to cause the UE 115 to receive an aperiodic trigger message that initiates transmission of the measurement report.

In some examples, the measurement configuration indicates a set of multiple first resources for transmission of uplink signals for self-interference measurements and a set of multiple second resources for self-interference measurements. In some examples, a linkage between the first resource for transmission of the uplink signal for the self-interference measurement and the second resource for the self-interference measurement is indicated in one or more of an RRC configuration of the second resource, a RRC configuration of the first resource, a CSI resource configuration, or a CSI report configuration.

In some examples, the measurement component 650 may be configured to cause the UE 115 to measure, during a time domain symbol of the second resource that includes the uplink signal, one or more self-interference metrics for one or more downlink sub-bands of the second resource. In some examples, the one or more self-interference metrics include one or more RSSI metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

In some examples, the second resource is identified based on a CLI measurement resource information element provided in the measurement configuration. In some examples, the second resource includes at least two least two time domain symbols, including a first time domain symbol that overlaps with the first resource and a second time domain symbol for measurement of CLI. In some examples, the second resource includes at least two least two time domain symbols, including a first time domain symbol for measurement of self-interference plus CLI, and a second time domain symbol for measurement of CLI only. In some examples, the CLI measurement resource is configured separately from the second resource, and is linked with the second resource via an RRC configuration.

In some examples, a transmit power for transmission of the uplink signal is based on one or more of a TCI power control parameter, a default power control parameter, or a configured power control parameter provided with the measurement configuration.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for providing a measurement configuration with SI and CLI measurement resources, and reporting of metrics related to SI, CLI, or both, which may allow a network entity to efficiently determine whether to enable full-duplex communications at a UE, parameters for full-duplex communications, or both.

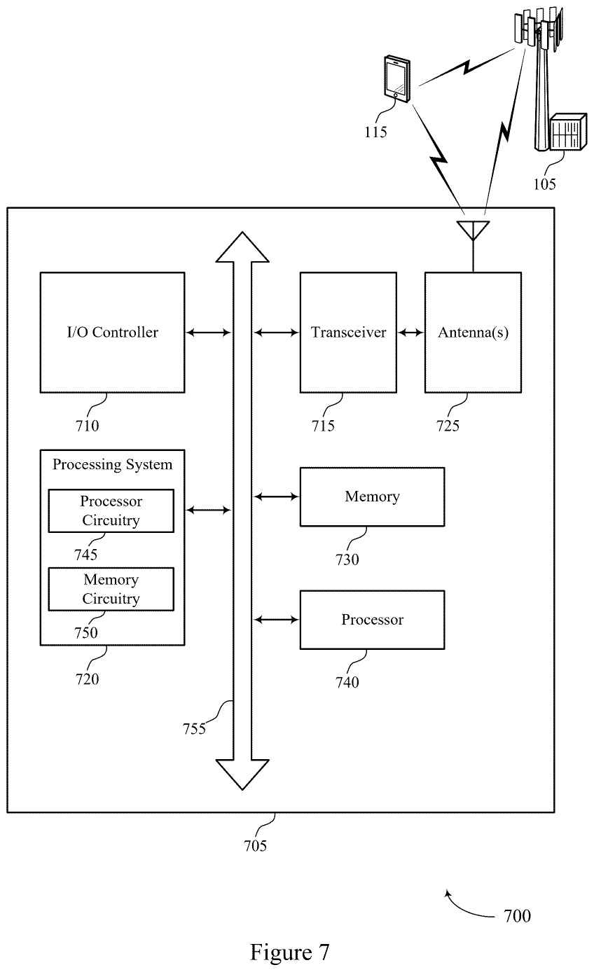

FIG. 7 shows an example of a system 700 including a device 705 that supports interference measurement for full duplex wireless communications. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as vial I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support interference measurement for full duplex wireless communications. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for providing a measurement configuration with SI and CLI measurement resources, and reporting of metrics related to SI, CLI, or both, which may allow a network entity to efficiently determine whether to enable full-duplex communications at a UE, parameters for full-duplex communications, or both.

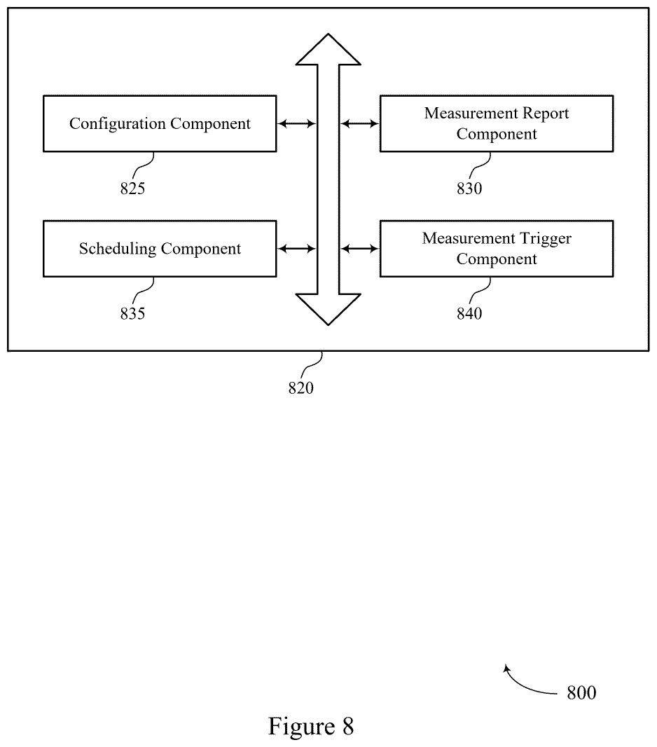

FIG. 8 shows an example 800 of a processing system 820 that supports interference measurement for full duplex wireless communications. A processing system 820 may be an example of a processing system 145 (such as network entity 105) and may include a configuration component 825, a measurement report component 830, a scheduling component 835, a measurement trigger component 840, or any combination thereof. A processing system 820, or various component thereof, may be an example of means for performing (such as a means for causing a network entity 105 to perform) various techniques described herein.

The configuration component 825 may be configured to cause the network entity 105 to output, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource. The measurement report component 830 may be configured to cause the network entity 105 to obtain, from the UE, a measurement report that indicates the self-interference measurement. The scheduling component 835 may be configured to cause the network entity 105 to schedule the UE with one or more full-duplex resources for communications based on the self-interference measurement.

In some examples, the first resource and the second resource include a same time domain symbol. In some examples, the UE is a first UE, and the measurement configuration further indicates a third resource for measurement of cross-link interference from an uplink transmission of a second UE during concurrent reception of downlink communications at the first UE, and where the measurement report indicates the self-interference measurement and a cross-link interference measurement measured on the third resource.

In some examples, the measurement trigger component 840 may be configured to cause the network entity 105 to output a trigger message to the UE that initiates transmission of the uplink signal using the first resource and that initiates the self-interference measurement on the second resource. In some examples, the measurement trigger component 840 may be configured to cause the network entity 105 to output an aperiodic trigger message to the UE that initiates the self-interference measurement and a cross-link interference measurement, and where the measurement report is provided responsive to the aperiodic trigger message. In some examples, the measurement configuration indicates a set of multiple second resources for self-interference measurements, and the measurement trigger component 840 may be configured to cause the network entity 105 to output an aperiodic trigger message to the UE that initiates transmission of the measurement report.

In some examples, the measurement configuration indicates a set of multiple first resources for transmission of uplink signals for self-interference measurements and a set of multiple second resources for self-interference measurements. In some examples, a linkage between the first resource for transmission of the uplink signal for the self-interference measurement and the second resource for the self-interference measurement is indicated in one or more of an RRC configuration of the second resource, a RRC configuration of the first resource, a CSI resource configuration, or a CSI report configuration.

In some examples, the measurement configuration indicates that the UE is to measure, during a time domain symbol of the second resource that includes the uplink signal, one or more self-interference metrics for one or more downlink sub-bands of the second resource. In some examples, the one or more self-interference metrics include one or more RSSI metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

In some examples, the second resource is identified based on a CLI measurement resource information element provided in the measurement configuration. In some examples, the second resource includes at least two least two time domain symbols, including a first time domain symbol that overlaps with the first resource and a second time domain symbol for measurement of CLI. In some examples, the second resource includes at least two least two time domain symbols, including a first time domain symbol for measurement of self-interference plus CLI, and a second time domain symbol for measurement of CLI only. In some examples, the CLI measurement resource is configured separately from the second resource, and is linked with the second resource via an RRC configuration.

In some examples, a transmit power for transmission of the uplink signal is based on one or more of a TCI power control parameter, a default power control parameter, or a configured power control parameter provided with the measurement configuration.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for providing a measurement configuration with SI and CLI measurement resources, and reporting of metrics related to SI, CLI, or both, which may allow a network entity to efficiently determine whether to enable full-duplex communications at a UE, parameters for full-duplex communications, or both.

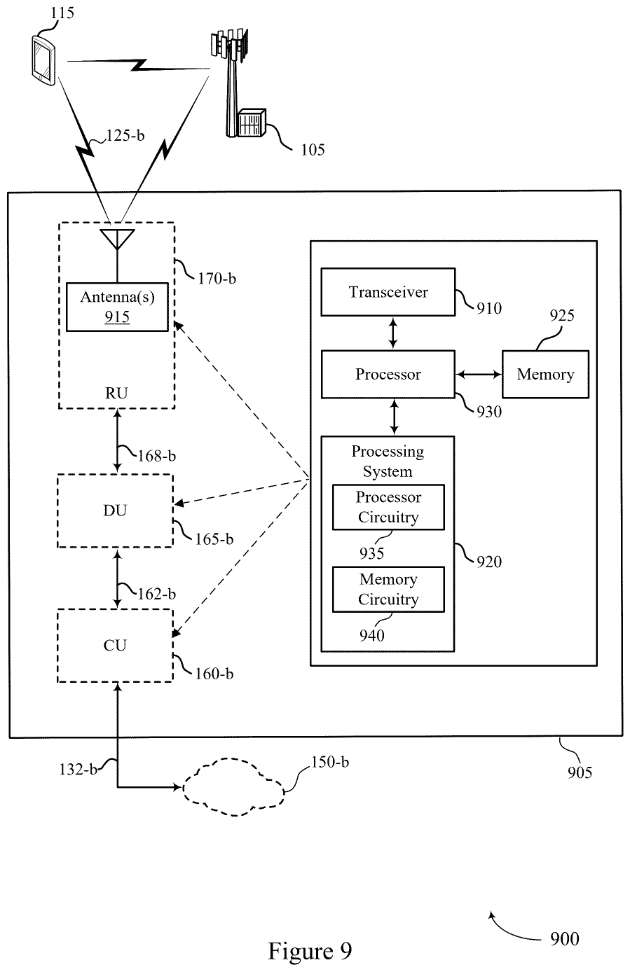

FIG. 9 shows an example of a system 900 including a device 905 that supports interference measurement for full duplex wireless communications. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support interference measurement for full duplex wireless communications. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for providing a measurement configuration with SI and CLI measurement resources, and reporting of metrics related to SI, CLI, or both, which may allow a network entity to efficiently determine whether to enable full-duplex communications at a UE, parameters for full-duplex communications, or both.

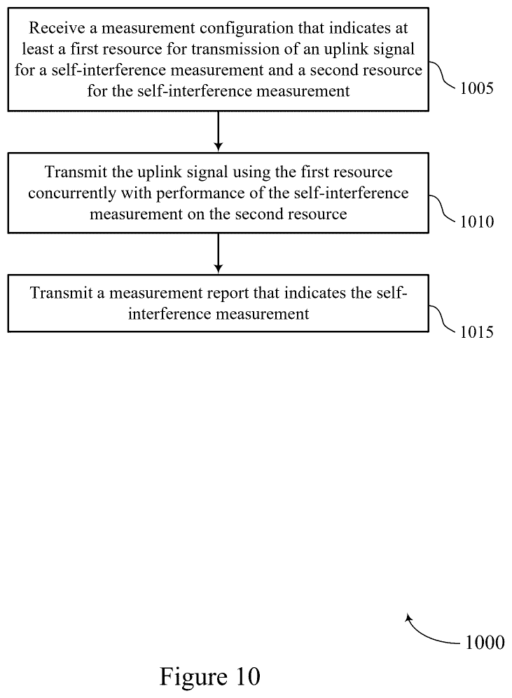

FIG. 10 shows an example of a method 1000 that supports interference measurement for full duplex wireless communications. Operations of the method 1000 may be performed by a UE or its components (such as using a processing system configured to cause the UE 115 to perform one or more of the operations) as described herein.

At 1005, the method may include receiving a measurement configuration that indicates at least a first resource for transmission of an uplink signal for a self-interference measurement and a second resource for the self-interference measurement. In some examples, aspects of the operations of 1005 may be performed by a configuration component 625.

At 1010, the method may include transmitting the uplink signal using the first resource concurrently with performance of the self-interference measurement on the second resource. In some examples, aspects of the operations of 1010 may be performed by a transmission component 630.

At 1015, the method may include transmitting a measurement report that indicates the self-interference measurement. In some examples, aspects of the operations of 1015 may be performed by a measurement report component 635.

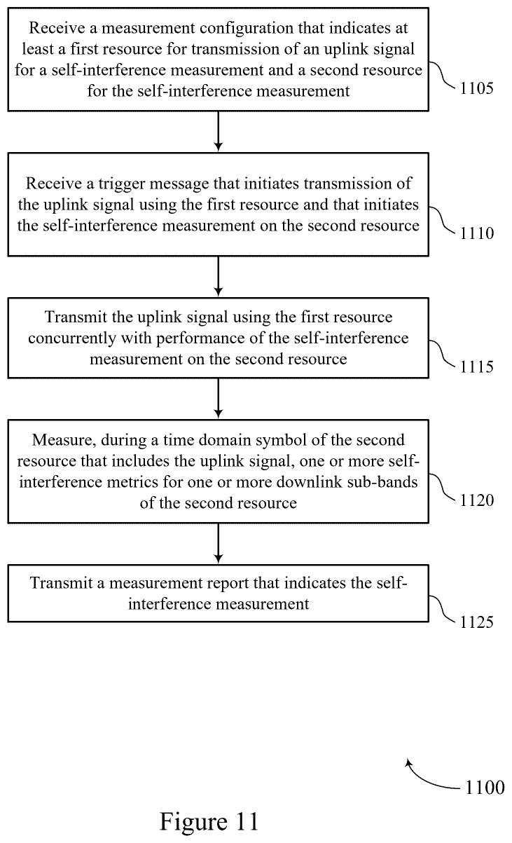

FIG. 11 shows an example of a method 1100 that supports interference measurement for full duplex wireless communications. Operations of the method 1100 may be performed by a UE or its components (such as using a processing system configured to cause the UE 115 to perform one or more of the operations) as described herein.

At 1105, the method may include receiving a measurement configuration that indicates at least a first resource for transmission of an uplink signal for a self-interference measurement and a second resource for the self-interference measurement. In some examples, aspects of the operations of 1105 may be performed by a configuration component 625.

At 1110, the method may include receiving a trigger message that initiates transmission of the uplink signal using the first resource and that initiates the self-interference measurement on the second resource. In some examples, aspects of the operations of 1110 may be performed by a measurement trigger component 645.

At 1115, the method may include transmitting the uplink signal using the first resource concurrently with performance of the self-interference measurement on the second resource. In some examples, aspects of the operations of 1115 may be performed by a transmission component 630.

At 1120, the method may include measuring, during a time domain symbol of the second resource that includes the uplink signal, one or more self-interference metrics for one or more downlink sub-bands of the second resource. In some examples, aspects of the operations of 1120 may be performed by a measurement component 650.

At 1125, the method may include transmitting a measurement report that indicates the self-interference measurement. In some examples, aspects of the operations of 1125 may be performed by a measurement report component 635.

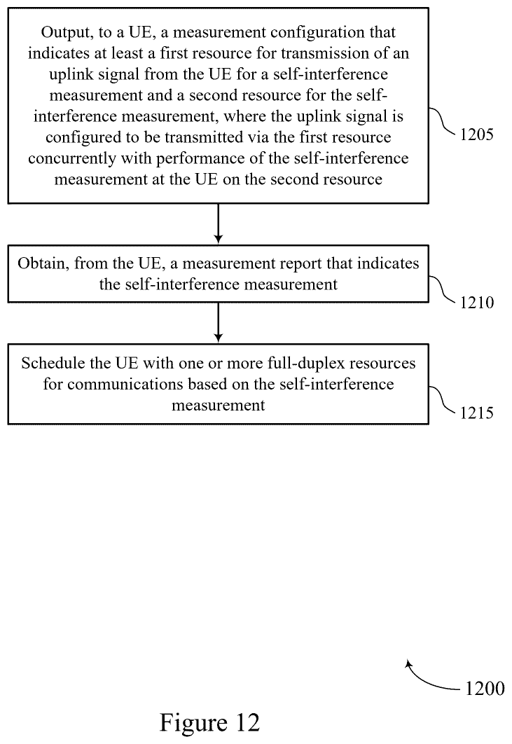

FIG. 12 shows an example of a method 1200 that supports interference measurement for full duplex wireless communications. Operations of the method 1200 may be performed by a network entity 105 or respective components (such as using a processing system configured to cause the respective device to perform one or more of the operations), as described herein.

At 1205, the method may include outputting, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource. In some examples, aspects of the operations of 1205 may be performed by a configuration component 825.

At 1210, the method may include obtaining, from the UE, a measurement report that indicates the self-interference measurement. In some examples, aspects of the operations of 1210 may be performed by a measurement report component 830.

At 1215, the method may include scheduling the UE with one or more full-duplex resources for communications based on the self-interference measurement. In some examples, aspects of the operations of 1215 may be performed by a scheduling component 835.

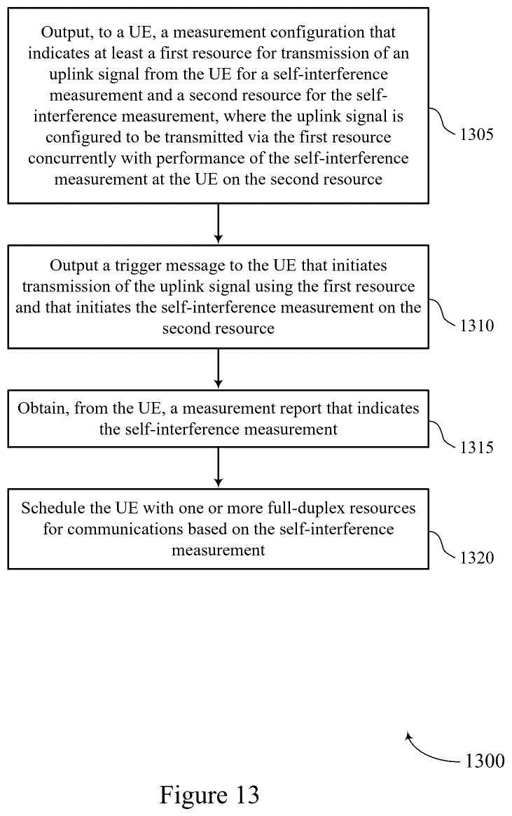

FIG. 13 shows an example of a method 1300 that supports interference measurement for full duplex wireless communications. Operations of the method 1300 may be performed by a network entity 105 or respective components (such as using a processing system configured to cause the respective device to perform one or more of the operations), as described herein.

At 1305, the method may include outputting, to a UE, a measurement configuration that indicates at least a first resource for transmission of an uplink signal from the UE for a self-interference measurement and a second resource for the self-interference measurement, where the uplink signal is configured to be transmitted via the first resource concurrently with performance of the self-interference measurement at the UE on the second resource. In some examples, aspects of the operations of 1305 may be performed by a configuration component 825.

At 1310, the method may include outputting a trigger message to the UE that initiates transmission of the uplink signal using the first resource and that initiates the self-interference measurement on the second resource. In some examples, aspects of the operations of 1310 may be performed by a measurement trigger component 840.

At 1315, the method may include obtaining, from the UE, a measurement report that indicates the self-interference measurement. In some examples, aspects of the operations of 1315 may be performed by a measurement report component 830.

At 1320, the method may include scheduling the UE with one or more full-duplex resources for communications based on the self-interference measurement. In some examples, aspects of the operations of 1320 may be performed by a scheduling component 835.

Implementation examples are described in the following numbered clauses:

Aspect 1: A method for wireless communications at a UE, comprising: receiving a measurement configuration that indicates at least a first resource for transmission of an uplink signal for a self-interference measurement and a second resource for the self-interference measurement; transmitting the uplink signal using the first resource concurrently with performance of the self-interference measurement on the second resource; and transmitting a measurement report that indicates the self-interference measurement.

Aspect 2: The method of aspect 1, wherein the first resource and the second resource include a same time domain symbol.

Aspect 3: The method of any of aspects 1 through 2, wherein the UE is a first UE, and the measurement configuration further indicates a third resource for measurement of cross-link interference from an uplink transmission of a second UE during concurrent reception of downlink communications at the first UE, and wherein the measurement report indicates the self-interference measurement and a cross-link interference measurement measured on the third resource.

Aspect 4: The method of any of aspects 1 through 3, further comprising: receiving a trigger message that initiates transmission of the uplink signal using the first resource and that initiates the self-interference measurement on the second resource.

Aspect 5: The method of any of aspects 1 through 3, further comprising: receiving an aperiodic trigger message that initiates the self-interference measurement and a cross-link interference measurement, and wherein transmitting the measurement report is based at least in part on the aperiodic trigger message.

Aspect 6: The method of any of aspects 1 through 3, wherein the measurement configuration indicates a plurality of second resources for self-interference measurements, and wherein the method further comprises: receiving an aperiodic trigger message that initiates transmission of the measurement report.

Aspect 7: The method of any of aspects 1 through 6, wherein the measurement configuration indicates a plurality of first resources for transmission of uplink signals for self-interference measurements and a plurality of second resources for self-interference measurements.

Aspect 8: The method of any of aspects 1 through 7, wherein a linkage between the first resource for transmission of the uplink signal for the self-interference measurement and the second resource for the self-interference measurement is indicated in one or more of: an RRC configuration of the second resource; a RRC configuration of the first resource; a CSI resource configuration; or a CSI report configuration.

Aspect 9: The method of any of aspects 1 through 8, further comprising: measuring, during a time domain symbol of the second resource that includes the uplink signal, one or more self-interference metrics for one or more downlink sub-bands of the second resource.

Aspect 10: The method of aspect 9, wherein the one or more self-interference metrics include one or more RSSI metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

Aspect 11: The method of any of aspects 1 through 10, wherein the second resource is identified based at least in part on a CLI measurement resource information element provided in the measurement configuration.

Aspect 12: The method of aspect 11, wherein the second resource includes at least two least two time domain symbols, including a first time domain symbol that overlaps with the first resource and a second time domain symbol for measurement of CLI.

Aspect 13: The method of any of aspects 11 through 12, wherein the second resource includes at least two least two time domain symbols, including a first time domain symbol for measurement of self-interference plus CLI, and a second time domain symbol for measurement of CLI only.

Aspect 14: The method of any of aspects 11 through 13, wherein the CLI measurement resource is configured separately from the second resource, and is linked with the second resource via an RRC configuration.

Aspect 15: The method of any of aspects 1 through 14, wherein a transmit power for transmission of the uplink signal is based at least in part on one or more of a TCI power control parameter, a default power control parameter, or a configured power control parameter provided with the measurement configuration.

Aspect 16: A method for wireless communications at a network entity, comprising: outputting, to a UE, a measurement configuration that indicates at least a first resource for transmission of an uplink signal from the UE for a self-interference measurement and a second resource for the self-interference measurement, wherein the uplink signal is configured to be transmitted via the first resource concurrently with performance of the self-interference measurement at the UE on the second resource; obtaining, from the UE, a measurement report that indicates the self-interference measurement; and scheduling the UE with one or more full-duplex resources for communications based at least in part on the self-interference measurement.

Aspect 17: The method of aspect 16, wherein the first resource and the second resource include a same time domain symbol.

Aspect 18: The method of any of aspects 16 through 17, wherein the UE is a first UE, and the measurement configuration further indicates a third resource for measurement of cross-link interference from an uplink transmission of a second UE during concurrent reception of downlink communications at the first UE, and wherein the measurement report indicates the self-interference measurement and a cross-link interference measurement measured on the third resource.

Aspect 19: The method of any of aspects 16 through 18, further comprising: outputting a trigger message to the UE that initiates transmission of the uplink signal using the first resource and that initiates the self-interference measurement on the second resource.

Aspect 20: The method of any of aspects 16 through 18, further comprising: outputting an aperiodic trigger message to the UE that initiates the self-interference measurement and a cross-link interference measurement, and wherein the measurement report is provided responsive to the aperiodic trigger message.

Aspect 21: The method of any of aspects 16 through 18, wherein the measurement configuration indicates a plurality of second resources for self-interference measurements, and wherein the method further comprises: outputting an aperiodic trigger message to the UE that initiates transmission of the measurement report.

Aspect 22: The method of any of aspects 16 through 21, wherein the measurement configuration indicates a plurality of first resources for transmission of uplink signals for self-interference measurements and a plurality of second resources for self-interference measurements.

Aspect 23: The method of any of aspects 16 through 22, wherein a linkage between the first resource for transmission of the uplink signal for the self-interference measurement and the second resource for the self-interference measurement is indicated in one or more of: an RRC configuration of the second resource; a RRC configuration of the first resource; a CSI resource configuration; or a CSI report configuration.

Aspect 24: The method of any of aspects 16 through 23, wherein the measurement configuration indicates that the UE is to measure, during a time domain symbol of the second resource that includes the uplink signal, one or more self-interference metrics for one or more downlink sub-bands of the second resource.

Aspect 25: The method of aspect 24, wherein the one or more self-interference metrics include one or more RSSI metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

Aspect 26: The method of any of aspects 16 through 25, wherein the second resource is identified based at least in part on a CLI measurement resource information element provided in the measurement configuration.

Aspect 27: The method of aspect 26, wherein the second resource includes at least two least two time domain symbols, including a first time domain symbol that overlaps with the first resource and a second time domain symbol for measurement of CLI.

Aspect 28: The method of any of aspects 26 through 27, wherein the second resource includes at least two least two time domain symbols, including a first time domain symbol for measurement of self-interference plus CLI, and a second time domain symbol for measurement of CLI only.

Aspect 29: The method of any of aspects 26 through 28, wherein the CLI measurement resource is configured separately from the second resource, and is linked with the second resource via an RRC configuration.

Aspect 30: The method of any of aspects 16 through 29, wherein a transmit power for transmission of the uplink signal is based at least in part on one or more of a TCI power control parameter, a default power control parameter, or a configured power control parameter provided with the measurement configuration.

68 Aspect 31: A UE for wireless communications, comprising a processing system that includes processor circuitry and memory circuitry that stores code, the processing system configured to cause the UE to perform a method of any of aspects 1 through 15.

Aspect 32: A UE for wireless communications, comprising at least one means for performing a method of any of aspects 1 through 15.

Aspect 33: A non-transitory computer-readable medium storing code for wireless communications, the code comprising instructions executable by one or more processors to perform a method of any of aspects 1 through 15.

Aspect 34: A network entity for wireless communications, comprising a processing system that includes processor circuitry and memory circuitry that stores code, the processing system configured to cause the network entity to perform a method of any of aspects 16 through 30.

Aspect 35: A network entity for wireless communications, comprising at least one means for performing a method of any of aspects 16 through 30.

Aspect 36: A non-transitory computer-readable medium storing code for wireless communications, the code comprising instructions executable by one or more processors to perform a method of any of aspects 16 through 30.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

A s used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

A s used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

A s used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a measurement configuration that indicates at least a first resource for transmission of an uplink signal for a self-interference measurement and a second resource for the self-interference measurement;
transmit the uplink signal using the first resource concurrently with performance of the self-interference measurement on the second resource; and
transmit a measurement report that indicates the self-interference measurement.

2. The UE of claim 1, wherein the first resource and the second resource include a same time domain symbol.

3. The UE of claim 1, wherein the UE is a first UE, and the measurement configuration further indicates a third resource for measurement of cross-link interference from an uplink transmission of a second UE during concurrent reception of downlink communications at the first UE, and wherein the measurement report indicates the self-interference measurement and a cross-link interference measurement measured on the third resource.

4. The UE of claim 1, wherein the processing system is further configured to cause the UE to:
receive a trigger message that initiates transmission of the uplink signal using the first resource and that initiates the self-interference measurement on the second resource.

5. The UE of claim 1, wherein the processing system is further configured to cause the UE to:
receive an aperiodic trigger message that initiates the self-interference measurement and a cross-link interference measurement, and wherein transmitting the measurement report is based at least in part on the aperiodic trigger message.

6. The UE of claim 1, wherein the measurement configuration indicates a plurality of second resources for self-interference measurements, and the processing system is further configured to cause the UE to:
receive an aperiodic trigger message that initiates transmission of the measurement report.

7. The UE of claim 1, wherein the measurement configuration indicates a plurality of first resources for transmission of uplink signals for self-interference measurements and a plurality of second resources for self-interference measurements.

8. The UE of claim 1, wherein:
a linkage between the first resource for transmission of the uplink signal for the self-interference measurement and the second resource for the self-interference measurement is indicated in one or more of:
a radio resource control (RRC) configuration of the second resource;
a RRC configuration of the first resource;
a channel state information (CSI) resource configuration; or
a CSI report configuration.

9. The UE of claim 1, wherein the processing system is further configured to cause the UE to:
measure, during a time domain symbol of the second resource that includes the uplink signal, one or more self-interference metrics for one or more downlink sub-bands of the second resource.

10. The UE of claim 9, wherein the one or more self-interference metrics include one or more received signal strength indicator (RSSI) metrics of the one or more downlink sub-bands, a difference between one or more RSSI metrics of the one or more downlink sub-bands and a cross-link interference RSSI metric for the one or more downlink sub-bands during a time domain symbol that does not include the uplink signal, or one or more transmit power metrics of the uplink signal.

11. The UE of claim 1, wherein the second resource is identified based at least in part on a cross-link interference (CLI) measurement resource information element provided in the measurement configuration.

12. The UE of claim 1, wherein a transmit power for transmission of the uplink signal is based at least in part on one or more of a transmission configuration indicator (TCI) power control parameter, a default power control parameter, or a configured power control parameter provided with the measurement configuration.

13. A method for wireless communications at a user equipment (UE), comprising:
receiving a measurement configuration that indicates at least a first resource for transmission of an uplink signal for a self-interference measurement and a second resource for the self-interference measurement;
transmitting the uplink signal using the first resource concurrently with performance of the self-interference measurement on the second resource; and
transmitting a measurement report that indicates the self-interference measurement.

14. The method of claim 13, wherein the UE is a first UE, and the measurement configuration further indicates a third resource for measurement of cross-link interference from an uplink transmission of a second UE during concurrent reception of downlink communications at the first UE, and wherein the measurement report indicates the self-interference measurement and a cross-link interference measurement measured on the third resource.

15. The method of claim 13, further comprising:
receiving a trigger message that initiates transmission of the uplink signal using the first resource and that initiates the self-interference measurement on the second resource.

16. The method of claim 13, wherein:
a linkage between the first resource for transmission of the uplink signal for the self-interference measurement and the second resource for the self-interference measurement is indicated in one or more of:
a radio resource control (RRC) configuration of the second resource;
a RRC configuration of the first resource;
a channel state information (CSI) resource configuration; or
a CSI report configuration.

17. The method of claim 13, wherein the second resource is identified based at least in part on a cross-link interference (CLI) measurement resource information element provided in the measurement configuration.

18. The method of claim 13, wherein a transmit power for transmission of the uplink signal is based at least in part on one or more of a transmission configuration indicator (TCI) power control parameter, a default power control parameter, or a configured power control parameter provided with the measurement configuration.

19. A non-transitory computer-readable medium storing code for wireless communications, the code comprising instructions executable by one or more processors to:
receive, at a user equipment (UE), a measurement configuration that indicates at least a first resource for transmission of an uplink signal for a self-interference measurement and a second resource for the self-interference measurement;
transmit the uplink signal using the first resource concurrently with performance of the self-interference measurement on the second resource; and
transmit a measurement report that indicates the self-interference measurement.

20. The non-transitory computer-readable medium of claim 19, wherein the UE is a first UE, and the measurement configuration further indicates a third resource for measurement of cross-link interference from an uplink transmission of a second UE during concurrent reception of downlink communications at the first UE, and wherein the measurement report indicates the self-interference measurement and a cross-link interference measurement measured on the third resource.
